(19) United States
(12) Patent Application Publication
(10) Pub. No.: US 2003/0198764 A1
(43) Pub. Date: Oct. 23, 2003

(54) Anti-fog heat shrinkable laminate useful for packaging

(76) Inventor: Terrance D. Kendig, Newark, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/125,959

(22) Filed: Apr. 19, 2002

(51) Int. Cl. B32B 1/02

(52) U.S. Cl. 428/34.9; 264/909

(57) ABSTRACT

The present invention is directed to a heat-shrinkable antifogging laminate for food packaging comprising a heat shinkage film, an adhesive layer, a film having less (or no) shrinkage and an anti-fog coating as well as a food package containing the heat shrunk laminate.

### BACKGROUND OF THE INVENTION

The present invention relates to a polyester containing shrinkable film laminate which contains an antifogging agent.

Packaging fresh refrigerated products such as meat or poultry require a clear view of the product inside the package. In many cases a packaging film is heat sealed to the lip or flange of a tray material to protect the product. In such cases there is an area of headspace between the product in the tray and the lidding film. This headspace is generally filled with a modified atmosphere to extend product shelf life. It is essential that the packaged product remain in clear view to the consumer at retail. In order to achieve this aesthetic, an antifogging agent is required to eliminate the undesirable visual effect caused by wet products that generate high humidity inside the package.

U.S. Pat. No. 5,567,533 to Toney, et al., describes an antifogging laminate of first substrate containing a first layer of a blend of polyelefin and an antifogging agent and a bonding layer of polyeolefin adhesively bonded to a second substrate of polyester or nylon.

A need exists in the food packaging industry for different laminate constructions with anti-fog properties.

### SUMMARY OF THE INVENTION

The present invention is direct to

A heat shrinkable film antifogging laminate useful for packaging comprising, in order:

(a) a heat shrinkable film comprising a polymer having at least 80% by weight polyethylene terephthalate polymer, wherein said film is biaxially oriented in the range of about 5% to about 55%, said film having an outer surface and an inner surface; and

(b) an adhesive layer; and

(c) a film having a heat shrinkage of at least 5% less than (a); and

(d) a coating consisting essentially of an anti-fog agent.

The present invention is further directed to a food package containing a laminate in which the heat shrinkable film has been shrunk by heat on a substrate which contains a food.

### DETAILED DESCRIPTION OF THE INVENTION

The present invention is directed to a particular type of polyethylene terephthalate (PET) shrink film, and methods related thereto, that offers advantages in packaging for a film requiring a clear view of a food. The invention is based on the platform of (a) a first layer of a film of polyethylene terephthalate polymer, either homopolymer or copolymer, that is heat-shrinkable, typically thin-gauge and having low shrinkage in combination with (b) a second layer of adhesive, (c) a third layer of a film having no shrinkage or less shrinkage than the heat shrinkable polyethylene terephthalate film, and (d) an anti-fog coating.

Furthermore, it is preferable in many applications for the four layer laminate to have an additional layer. The fifth layer acts to impart an oxygen and moisture barrier to the laminate which is critical in many food packaging applications. This layer is adjacent the heat shrinkable film containing PET. Although the barrier layer can be on either side of the heat-shrinkable film, preferably it is intermediate the heat shrinkable film and the solventless or solvent type laminating adhesive coating. A preferred example of a barrier layer is made from polyvinylidine chloride (PVDC).

Appearance of the layers is an important criteria in food packaging. The appearance is desired when packaging cuts of fresh meat or other products including vegetable and fruits packaged in modified atmospheric conditions to extend product shelf life.

Heat Shrinkable Film

The heat-shrinkable, polyethylene shrink film, i.e. “base film” of the present invention comprises at least about 80 wt % PET, more preferably at least 90 wt % PET. The PET can be a homopolymer or copolymer of PET. A PET homopolymer is intended to mean a polymer substantially derived from the polymerization of ethylene glycol with terephthalic acid, or alternatively, derived from the ester forming equivalents thereof (e.g., any reactants which can be polymerized to ultimately provide a polymer of polyethylene terephthalate). A copolymer of PET is intended to mean any polymer comprising (or derived from) at least about 50 mole percent ethylene terephthalate, and the remainder of the polymer being derived from monomers other than terephthalic acid and ethylene glycol (or their ester forming equivalents).

The PET base films of the present invention are further defined as:

being biaxially oriented in the range of about 5%-55% shrink factor, more preferably in the range of about 5% or 10%-30% shrink factor.

In some applications such as for lidding having a thickness in the range of 12-75 micrometers (more preferably 12-20 micrometers) would typically employed. Suitable polyethylene terephthalate shrink films are available from DuPont Teijin Films under the trademarks Mylar® and Melinex®.

Relative to conventional shrink film, the shrink film of the present invention are advantageous in packaging applications for a number of reason. The PET shrink film is tough relative to many conventional shrink films, and the film's relatively small amount of orientation (“low shrinkage”) has been found to better accommodate protrusions, by not shrinking to such an extent as to risk puncturing the film or crushing protruding contents and by not shrinking to such an extent as to agglomerate an ugly mass of shrunken film around the protrusion or to deform the container after lidding.

When first shrunk to a package, the base film of the present invention forms a tight hermetic seal due to the presence of the sealant layers. Seals can be made to an outer wall, outer lip edge, top of the lip and bridges separating compartments to prevent spillage from one to the other. Another advantage is this type of construction can be used in a variety of Modified Atmospheric Packaging (MAP) formats.

The relatively low shrink force films of the present invention also provide excellent appearance and are generally more economical to use than conventional (higher gauge, higher shrinking) shrink films, especially for lidding applications, because they minimize the amount of material needed for coverage of the product and container being used.

The heat shrinkable PET base film has other additional advantages. It can be surface printed stand alone or trap printed when laminating. It can be laminated, carrying varying degrees of shrink % 5-45, to a secondary web, dependent upon the thickness, stiffness and shrinkage of said second web. The percent shrink of the shrinkable PET in turn governs shrinkage of the final structure.

The shrinkage of the PET base film and the additional films to be laminated can be significantly different, in fact shrinkage differences of about 5% and much greater pose no problem. The amount of shrinkage will be dictated by the heat-shrinkable PET base, but also by the thickness and stiffness of another film. An example would be when adhesive laminating to a thicker or stiffer substrate, in order to gain the shrinkage desired from the laminate, a higher percentage of shrinkage may be required of the PET base sheet.

Generally corona treatment prior to application of a laminating adhesive is desirable in order to promote better bonding between the film surfaces.

The heat-shrinkable, heat-sealable laminate film is recommended when lidding disposable containers, particularly trays made of crystalline PET (CPET), amorphous PET (APET), paper aluminum, polypropylene (PP), polyethylene (PE), polyvinyl chloride (PVC), polyvinylidene chloride (PVDC) or polystyrene (PS). the desired substrate determines what material sealant web is to be laminated to the heat shrinkable PET base film.

Adhesive

The type of adhesive employed in the preent invention is not considered critical provided bonding of the heat shrinkage film takes place to a film having at least less shrinkage.

Solventless laminating adhesives are well know in the art and illustratively include waterborne acrylic emulsions, polyurethane dispersions and one and two part 100% solids polyurethane systems. Waterborne systems require dryers after adhesive application at elevated temperatures to eliminate the water before combining with another substrate. On the other hand 100% solids polyurethane systems rely on a chemical reaction for curing and little or no heat is required.

A preferred class of adhesives are elastomeric such as polyurethanes. However, the adhesive need not be elastomeric.

Solvent type adhesives can also be used and a preferred type is Lamal HSA/Catalyst CR-1-80 as supplied by Rohm & Haas. Lamal HSA adhesive is the polyether urethane component of a two-component laminating adhesive which requires the use of a coreactant. This polyether urethane, with coreactant is commonly used in meat, cheese, snack food packaging, label stock, bag and pouch laminations.

Lamal HSA adhesive is different from most conventional polyurethane adhesives in that it has an ability to withstand contact with alcohols or small amounts of water. Denatured alcohol and isopropanol are most commonly used as a dilutent for the adhesive.

The adhesive is designed to give high bond strength to a variety of substrates such as those stated above as well as provide optical clarity, high heat resistance and moderate chemical resistance. It is also very effective when laminating heat sensitive substrates where low drying and nipping temperatures are desirable.

The laminating adhesives can be applied either to the heat shrinkable film of (a) previously described or to a film having heat shrinkage of at least 5% less than (a). One or both of these films can be surface treated such as by corona discharge. However such pretreatment is not essential in obtaining the results of the present invention. The laminating adhesive can be applied by well known coating techniques such as metering a low viscosity adhesive onto a multiple application roll system configuration that applies the adhesive to a first web or substrate.

Additional Film

An additional film necessary in the present invention has a heat shrinkage of at least 5% less than the heat shrinkage film, previously described. Preferably the heat shrinkage is at least 10%. It is understood that the above heat shrinkage numerical values are inclusive of films which have no heat shrinkage. In many applications it is preferred that the final film has no shrinkage under the conditions in which contraction of the heat shrinkage film occurs. Examples of polymeric films useful for the final film are nylon, polypropylene, polyethylene, ionomer, acid copolymer, ethylene vinyl acetate, polyethylene terephthalate, polystyrene, ethylene vinyl alcohol, polyvinylidene choloride, multi-layer coextrusions and combinations thereof.

The additional film is bonded to the heat shrinkable film employing the previously described adhesive. This additional film serves as the support of the antifogging agent.

Antifogging Agent

The further required layer in the present invention comprises an antifogging agent typically applied as a coating. The term “antifogging agent” describes a chemical or composition which prevents or retards water formation on a surface of a film. The presence of water such as water droplets or fogging on a film surface is undesirable from an aesthetic viewpoint. A consumer making a choice in purchase of a food product has a requirement to clearly see the product when packaged with a clear film.

As employed herein the term “antifogging agent” excludes the presence of a material which interferes with the antifogging property. An example of such material is the use of a layer containing a polymer with the antifogging agent contained thereon. U.S. Pat. No. 5,567,533 discloses a blend of polyolefin and an antifogging agent which lies outside the scope of the present invention. Therefore in the present disclosure “consisting essentially of an antifogging agent” allows the incorporation of added components which allow adhesion of the antifogging agent to a base film. However components are excluded which dilute or interfere with the ability of the antifogging agent to prevent or minimize water deposition including use of a polymer with the antifogging agent embedded therein.

An added step is necessary in the present invention in applying a coating of the antifogging agent to a film such as an olefin compared to U.S. Pat. No. 5,567,533 wherein a mixture of the antifogging agent and olefin is utilized. However, when the antifogging agent is present in the olefin, migration of the antifogging agent occurs not only to a desired surface to prevent water deposition but also to an opposite side of the film. In such instance the antifogging agent can interfere with adhesion of another layer which results in added design requirements, e.g. the use of an added layer. This problem and added design is eliminated in the present invention.

Antifogging agents which are likewise disclosed in U.S. Pat. No. 5,567,533 are typically surfactants which are designed to reduce surface tension of water. Examples of such agents include sorbitan, fatty esters, glycerol monostearate, glycerol monooleate and fatty alcohols.

The application of an antifogging agent to the underlying film can be conventional coating techniques. Typically the antifogging agent would be diluted with a compatible liquid. In many instances ethanol, methanol or isoproponal would be employed. Some antifogging agents are sold as proprietary blends without a complete description of active components. However, dilution with an appropriate liquid can be easily determined. Examples of suitable dilution ratios are 0.2% to 10% by volume and more typically 1% to 2%. An example of a coating technique is with use of a gravure cylinder. Gravure cylinder cell size and dilution ratios can be adjusted to apply a desired amount of anti-fog coating. The anti fog would also be useful if applied as a pattern or registered on the film similar to printing methods. One benefit may be placing the anti fog in areas on the film where it is useful and out of the area where the film is sealed.

Examples of polymeric films useful for the anti fog surface coating application process creating a final film are nylon, polypropylene, polyethylene, ionomer, acid copolymer, ethylene vinyl acetate, polyethylene terephthalate, polystyrene, ethylene vinyl alcohol, polyvinylidene chloride, multi-layer coextrusions and combinations thereof.

Barrier Coating

In food packaging applications particularly where resistance to oxygen and moisture is needed it is preferred in the present invention to employ a barrier layer.

The barrier layer is adjacent the heat shrinkable PET base film. “Adjacent” in the present context means the barrier layer can be on either side of the PET base film. Accordingly the barrier may be on the base film side opposite (i.e. away from) the required solventless or solvent type laminating adhesive, however preferably the barrier is intermediate the PET base film and the solventless or solvent type adhesive.

A preferred barrier layer is a vinylidene polymer and particularly polyvinylidine chloride polymer including copolymers. These barrier layers are well known and are valuable to the food packaging industry because they provide superior resistance to fat, oil, water and steam as well as resistance to permeation of gas and odors.

Application of barrier coatings are well known and include gravure or roller coating. However, when removal of any solvent is necessary from the barrier coating, care must be taken to prevent premature shrinking of the base PET film due application of heat.

To further illustrate the present invention, the following examples are provided. In the examples the dilution percentage is by volume.

### EXAMPLE I

### Coating

A first substrate of 80 gauge saran coated heat shrinkable polyester film known under the tradename Mylar® supplied by DuPont Teijin Films is adhesive laminated to a second substrate of 1.25 mil linear low density polyethylene (LLDPE). The lamination is made by 1) applying a solvent type adhesive Lamal HSA/Catalyst CR-1-80 to the saran coated side of Mylar® by an engraved gravure cylinder at a coating station 2) running and drying the adhesive coated web through a hot air oven at 170° F. and 3) hot nipping the Mylar® at 150° F. to the secondary substrate of LLDPE and winding up the roll thus completing the lamination. It is critical to use adhesive components than can be dried below the heat shrink initiation point of the primary web.

The adhesive in the coating station is replaced with a diluted solution of Atmer 100 antifogging agent. Diluting 1% of the antifogging agent in isopropanol made the solution. The laminate is unwound and taken though the coating station using a 200 quad engraved gravure cylinder to apply the anti-fog solution to the LLDPE side of the film. This side will be used as the lidstock to seal to the tray material and also provide the anti-fog surface interface between the headspace and the product packaged. After the anti-fog solution is applied, the web was then passed though a hot air dryer at 160° F. in order to remove the solvent and dry the surface. The roll was then wound up into the finished product. The same process was used applying 2%, 3% and 5% anti-fog solutions to the same laminated film structure. In all cases the film remained clear and had excellent sealability.

### EXAMPLE II

In this example the procedure of Example I was followed except for substitution of additional Atmer antifogging agents as noted. The laminate was heat sealed to a tray having a wet towel placed at the bottom of the tray. The lidding film was exposed to temperatures of 33.5° F. (1° C.) and 40° F. (4.4° C.) with antifogging performance measure.

Anti-Fog Testing Protocol

1. Wet paper towel placed in the bottom of tray.

2. Seal the tray hermetically with the anti-fog film leaving headspace between wet towel and plastic lidding film.

3. Expose lidded tray at temperatures of 33.5° F.-40° F.

4. Observe antifogging performance after 2 hours, 4 hours, 6 hours, 24 hours and 48 hours.

| | | | Appearance | | | | |
|---|---|---|---|---|---|---|---|
| Topcoat ID | % | Temperature | 2 Hours | 4 Hours | 6 Hours | 24 Hours | 48 Hours |
| Atmer 100 | 2 | 32 F. | 6 | 6 | 6 | 6 | 5 |
| Atmer 100 | 2 | 40 F. | 6 | 6 | 5 | 5 | 5 |
| Atmer 645 | 2 | 32 F. | 3 | 3 | 5 | 5 | 5 |
| Atmer 645 | 2 | 40 F. | 5 | 5 | 5 | 5 | 5 |
| Atmer 685 | 2 | 32 F. | 2 | 2 | 2 | 2 | 2 |
| Atmer 685 | 2 | 40 F. | 2 | 2 | 2 | 2 | 5 |
| Atmer 100 | 3 | 32 F. | 6 | 6 | 6 | 6 | 6 |
| Atmer 100 | 3 | 40 F. | 6 | 6 | 6 | 5 | 5 |
| Atmer 645 | 3 | 32 F. | 3 | 3 | 5 | 5 | 5 |
| Atmer 645 | 3 | 40 F. | 5 | 5 | 5 | 5 | 5 |
| Atmer 685 | 3 | 32 F. | 3 | 3 | 5 | 5 | 5 |
| Atmer 685 | 3 | 40 F. | 2 | 2 | 2 | 2 | 5 |
| Atmer 100 | 5 | 32 F. | 6 | 6 | 6 | 6 | 6 |
| Atmer 100 | 5 | 40 F. | 6 | 6 | 6 | 6 | 5 |
| Atmer 645 | 5 | 32 F. | 3 | 3 | 5 | 5 | 5 |
| Atmer 645 | 5 | 40 F. | 5 | 5 | 5 | 5 | 5 |
| Atmer 685 | 5 | 32 F. | 6 | 6 | 6 | 5 | 5 |
| Atmer 685 | 5 | 40 F. | 6 | 3 | 5 | 5 | 5 |

Appearance Ratings:
1 = fogging/condensate
2 = clear condensate—many droplets
3 = clear/condensate—few droplets
4 = clear/condensate—minimal droplets
5 = clear condensate—total wetout 1 drop
6 = no visible change/no condensate

1. A heat shrinkable film antifogging laminate useful for packaging comprising, in order:
(a) a heat shrinkable film comprising a polymer having at least 80% by weight polyethylene terephthalate polymer, wherein said film is biaxially oriented in the range of about 5% to about 55%, said film having an outer surface and an inner surface; and
(b) an adhesive layer; and
(c) a film having a heat shrinkage of at least 5% less than (a); and
(d) a coating consisting essentially of an anti-fog agent.

2. The laminate of claim 1 wherein the film of (c) having a heat shrinkage of at least 10% less than (a).

3. The laminate of claim 1 wherein the film of (c) having substantially no heat shrinkage.

4. The laminate of claim 1 wherein the film of (c) is selected from the group consisting of nylon, polypropylene, polyethylene, ionomer, acid copolymer, ethylene vinyl acetate, polyethylene terephthalate, polystyrene, ethylene vinyl alcohol, polyvinylidene chloride, and coextruded combinations thereof.

5. The laminate of claim 1 wherein the adhesive coating (b) is solventless.

6. The laminate of claim 1 wherein the adhesive coating (b) initially contains a solvent.

7. A package containing a food comprising a substrate in combination with laminate derived from a heat shrinkable film laminate comprising in order:
(a) a film which has been shrunk by heat from a heat shrinkable film comprising a polymer having at least 80% by weight polyethylene terephthalate polymer, wherein said film is biaxially oriented in the range of about 5% to about 55%, said film having an outer surface and an inner surface; and
(b) an adhesive layer; and
(c) a film which is derived from a film having a heat shrinkage of at least 5% less than (a); and
(d) a coating consisting essentially of an anti-fog layer wherein the laminate covers a surface portion of a substrate which supports a food.

8. The package of claim 7 wherein the substrate is a tray.
